(19) United States
(12) Patent Application Publication
(10) Pub. No.: US 2008/0031548 A1
(43) Pub. Date: Feb. 7, 2008

(54) SYSTEMS AND METHODS FOR DATA TRANSFORMATION

(75) Inventors: Robert M. Brinson JR., Rome, GA (US); Bryan G. Donaldson, Cumming, GA (US); Nicholas L. Middleton, Cartersville, GA (US); Harry H. Blakeslee, Dunwoody, GA (US); Anamika Saxena, Alpharetta, GA (US)

Correspondence Address: BLACK LOWE & GRAHAM, PLLC, 701 FIFTH AVENUE, SUITE 4800, SEATTLE, WA, 98104, US

(73) Assignee: INTELLISCIENCE CORPORATION, Atlanta, GA (US)

(21) Appl. No.: 11/839,479

(22) Filed: Aug. 15, 2007

Related U.S. Application Data
(63) Continuation-in-part of application No. 11/689,361, filed on Mar. 21, 2007.
(60) Provisional application No. 60/822,434, filed on Aug. 15, 2006.
(60) Provisional application No. 60/871,745, filed on Dec. 22, 2006.
(60) Provisional application No. 60/743,711, filed on Mar. 23, 2006.

(51) Int. Cl. G06K 9/60

(52) U.S. Cl. 382/305

(57) ABSTRACT

In an embodiment, a two-dimensional, grey-scale image is the data type to be analyzed, and a plurality of pixels which compose an image, are referred to as a data element. The image is analyzed and each pixel is assigned a value, for example from 0-255; in one embodiment, the values are stored in a system cache or a data store. A new image file is created and configured to be the same size as the original image and capable of storing a numerical representation of each pixel. An algorithmic analysis is performed on the data stored from the grey-scale image, resulting in a new value being stored in the new image file. The resulting image is created from these values and represents a new transformed image.

### PRIORITY CLAIM

This application claims the benefit of U.S. Provisional Application Ser. Nos. 60/822,434 filed on Aug. 15, 2006, and 60/871,745 filed on Dec. 22, 2006; and is a Continuation-In-Part of U.S. application Ser. No. 11/689,361 filed on Mar. 21, 2007, which claims priority to 60/743,711 filed on Mar. 23, 2006, all of which are herein incorporated by reference in their entirety.

### BACKGROUND OF THE INVENTION

Often a data analysis system is presented with a sampling of data that contains obscure or indiscernible data patterns that are difficult or impossible to discriminate using human sensory analysis or even conventional data manipulation methodologies. In the cases of an image of a black night sky or a sound file containing several strong voice inputs and barely audible, muffled background inputs, the user may be unable to definitively highlight a known feature(s) of interest due to the vagueness and ambiguity of the data in the original sample. True to any method of data analysis and manipulation is that new data should never be created or manufactured from existing raw data. While the need to represent and visualize the raw data in new and unique manners in order to garner a more thorough understanding of the information represented therein is certainly recognized, many data analysis and manipulation products available on the market today tend to create potentially irrelevant data from the existing raw data when attempting to offer alternative visualization opportunities. Such is the case in the zooming in and out of an image, for example, where the existing raw data is used to extrapolate data values not inherent to the original image. In many cases, this fabricated data is generated at the expense of accuracy and relevancy to the real world and is most assuredly limited in value and usefulness to a user, even if the user does not realize it at the time.

### SUMMARY OF THE INVENTION

In an embodiment, a two-dimensional, grey-scale image is the data type to be analyzed, and a plurality of pixels which compose an image, are referred to as a data element. The image is analyzed and each pixel is assigned a value, for example from 0-255; in one embodiment, the values are stored in a system cache or a data store. A new image file is created and configured to be the same size as the original image and capable of storing a numerical representation of each pixel. An algorithmic analysis is performed on the data stored from the grey-scale image, resulting in a new value being stored in the new image file. The resulting image is created from these values and represents a new transformed image.

### BRIEF DESCRIPTION OF THE DRAWINGS

The preferred and alternative embodiments of the present invention are described in detail below with reference to the following drawings.

FIG. 1 shows an example system 100 for executing a Data Transformation System;

FIG. 2 shows a method for successful data transformation of a given raw data set;

FIG. 3 depicts an adjacent pixel data evaluation sample;

FIG. 4 shows a target-like data evaluation sample;

FIGS. 5A-B show the starburst-like data evaluation sample;

FIG. 6 shows an original ten-pixel by ten-pixel raw data set example;

FIG. 7 shows a sample pixel and its associated adjacent pixel data evaluation sample as used in a system and method for data transformation;

FIG. 8 shows a data array for the data overlay as generated from transformation of the original ten-pixel by ten-pixel raw data set with the “Mean” (A1) algorithm and the adjacent pixel data evaluation sample;

FIG. 9 shows a data overlay as generated from transformation of the original ten-pixel by ten-pixel raw data set with the “Median” (A2) algorithm and the adjacent pixel data evaluation sample;

FIG. 10 shows a data overlay as generated from transformation of the original ten-pixel by ten-pixel raw data set with the “Spread” (A3) algorithm and the adjacent pixel data evaluation sample;

FIG. 11 shows a star cloud image used for data transformation;

FIGS. 12A-12C show transformed images of the star cloud image using three different transformation algorithms;

FIG. 12D shows a composite transformed image using three different transformation algorithms, one each placed in the red, green and blue bands.

FIG. 13 shows a ring of Saturn used for data transformation;

FIGS. 14A, C and E show transformed images of the ring of Saturn using three different transformation algorithms.

FIGS. 14 B, D and F show the transformed images 14 A, C and E respectively in the contrasting color palette visualization.

FIG. 14G shows a composite transformed image using three different transformation algorithms, one each placed in the red, green and blue bands.

FIG. 15 shows an image of Saturn used for data transformation; and

FIGS. 16A-C show transformed images of Saturn using three different transformation algorithms.

### DETAILED DESCRIPTION OF THE PREFERRED EMBODIMENT

Systems and methods of one embodiment include accurately, efficiently and effectively transforming the raw data elements of an original data set into new, useful and relevant transformed data without sacrificing the inherent meaning or innateness of the raw data. Transformation of this raw data avoids the potential relinquishment of substantial meaning and detail that often results when new data is created or generated from raw data and provides an alternative means by which to visualize the raw data thereby possibly revealing the existence of previously indiscernible, unobvious or obscure information.

Various embodiments of the present invention lend themselves neatly to applicability in a diverse array of industries. Assuming the proper approach and techniques, raw data may be analyzed and transformed quickly, efficiently and relevantly into new and useful data in an effort to potentially yield important analytical results and discoveries that may not have been possible given the raw data alone.

For example, transformation of dark imagery, such as a blackened night sky, with an embodiment of the present invention may reveal the fading condensation trail (also known as “contrail”) of an enemy jet aircraft trespassing in the air space of a particular country, unnoticed or previously-unobserved stars or other heavenly bodies, and/or various atmospheric phenomena. In one embodiment, transformation of a digital image of a historically-famous painting may reveal a painter's hidden brush strokes, which may have been previously undetectable to the naked human eye, and thus prove fraudulency. In an alternate embodiment, data transformation may be employed to pinpoint the firing location(s) of missiles through analysis of imagery containing human-imperceptible air disturbances, while in yet another embodiment, the present invention may be useful as a purely aesthetic art application appealing to varied demographic groups, artists and advertising agents, for example, who may be interested in transforming imagery into something fantastic or bizarre. In an alternate embodiment, a sound sample may be transformed to mimic or create a particular sound effect. Additional alternate embodiments may also include data analysis, transformation and visualization results utilized to reveal ambiguous patterns or obscure information within financial or stock market data, seismographic readings, olfactory data, etc.

Although several of the data analysis embodiments and examples as discussed herein are described with reference to specific data types, such as image or sound data, the present invention is not limited in scope or breadth to analysis of these data types alone. The methods and systems as described herein may be used to transform and visualize data of any data type, modality, submodality, etc., that may be represented in a quantifiable datastore.

As used herein, the terms “subject data element” or “valid data element” refer to a discrete point of a larger data set of a given type, modality, submodality, etc., of data or media that is being evaluated for characteristics using algorithms. The subject data element may be any size appropriate for a particular data type, modality, submodality, etc. In one embodiment, such as the data analysis and feature recognition system as presented in U.S. Provisional Application Ser. No. 60/743,711 as filed on Mar. 23, 2006, and U.S. application Ser. No. 11/689,361 as filed on Mar. 21, 2007, the subject data element may be described as the target data element, or TDE; within a two-dimensional imagery embodiment, for example, the subject data element may consist of a single pixel, a plurality of localized pixels or any other discrete grouping of pixels. In several embodiments, regardless of size, a subject data element is a “point” that is evaluated in a single discrete step before evaluation moves on to the next subject data element.

As used herein, the term “data evaluation sample” refers to an ordered collection of data immediately surrounding a subject data element(s) at the center of interest. The size and shape of the data evaluation sample may define the data element(s) available for algorithmic evaluation during data analysis, transformation and/or visualization processes and may vary depending upon, but not limited to, the type, modality, submodality, etc., of the data or media being evaluated, user specifications, and/or industry- or system-acceptable standards. In one embodiment, such as the data analysis and feature recognition system as presented in U.S. Provisional Application Ser. No. 60/743,711 as filed on Mar. 23, 2006, and U.S. application Ser. No. 11/689,361 as filed on Mar. 21, 2007, the data evaluation sample may be described as a target data area, or TDA, wherein a series of geometrically-aligned or patterned data elements surround a subject data element(s) at the center.

As used herein, the term “algorithm” carries its normal meaning and refers without limitation to any series of repeatable steps that result in a discrete “value.” For example, an algorithm may include any mathematical, statistical, positional and/or relational calculation between any number of user-specified, preset, automatically-determined, and/or industry- or system-acceptable data elements. In several embodiments, various algorithms may be performed on subject data elements in relation to a previously defined data evaluation sample in order to produce a single, meaningful data value.

As used herein, the term “color model” as used with reference to the imagery data type and as a form of multi-banded imagery data, is an abstract mathematical model describing the way in which the colors of human vision are represented as combinations of numbers. With regard to the CMYK (cyan, magenta, yellow and black) color model, the ideal mixture of cyan, magenta and yellow colors is subtractive such that when printed together on the same white substrate, the “brightness” of the white substrate is subtracted, or all associated wavelengths of light are absorbed, thereby leaving only black. In contrast, the RGB color model is additive wherein certain combinations of red, green and blue color intensities are combined in various ways to produce other colors. Typical display adapters (e.g., computer monitors) use up to 24-bits of information for each pixel, and this is usually apportioned with eight bits each for red, green and blue thereby resulting in a range of 256 possible values for each hue. In an alternate embodiment, the image may be a grey-scale color image, which is known as single-banded data.

As used herein, the term “data (i.e., image, sound, seismic, financial, etc.) overlay” refers to a process whereby visible feedback, resulting from some algorithmic processing of the raw data set, is created and/or displayed without altering the original raw data set.

As used herein, the term “N-order processing” refers to the calculation(s) of derivative values on algorithm values calculated in previous processing passes.

As used herein, the terms “data transformation” and “transformation” refer to a process that occurs when one or more user-specified or preset transformation algorithms are used to process one data band of a data element (e.g., in an imagery embodiment, the red band of a pixel) or a plurality of data bands of one or a plurality of data elements (e.g., in an imagery embodiment, the red and blue bands of a pixel or a plurality of pixels). After transformation, a new data overlay is created for the algorithmically-transformed data values.

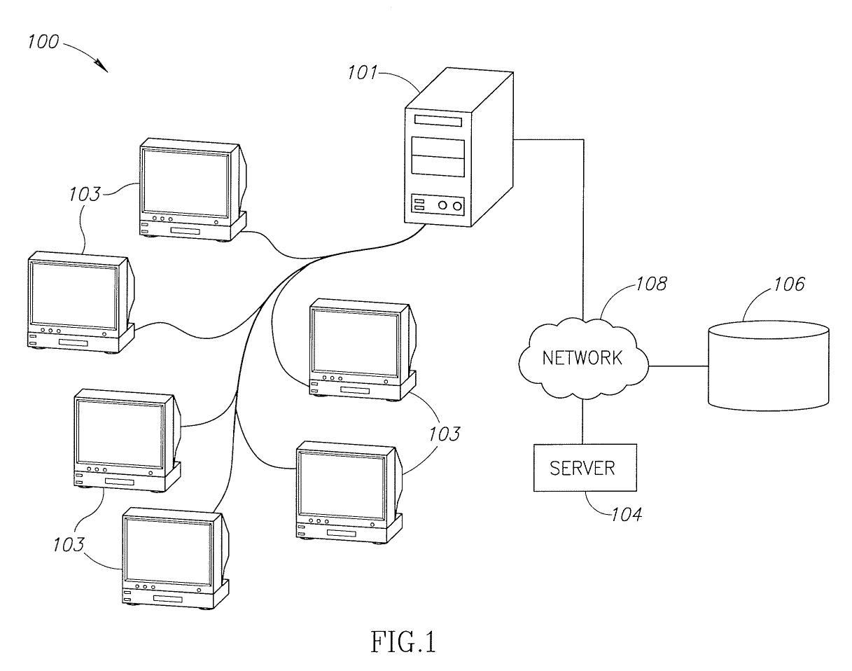

FIG. 1 shows an example system 100 for executing a Data Transformation System. In one embodiment, the system 100 includes a single computer 101. In an alternate embodiment, the system 100 includes a computer 101 in communication with a plurality of other computers 103. In an alternate embodiment, the computer 101 is connected with a plurality of computers 103, a server 104, a data store 106, and/or a network 108, such as an intranet or the Internet. In yet another alternate embodiment a bank of servers, a wireless device, a cellular phone and/or another data entry device can be used in place of the computer 101. In one embodiment, a datastore 106 stores processed results of at least one algorithm performed on a data set. The datastore can be stored locally at the computer 101 or at any remote location while being retrievable by the computer 101. In one embodiment, an application program is run by the server 104 or by the computer 101, which then creates the datastore. The computer 101 or server 104 can include an application program that processes a data element in a data set. For example, the computer 101 or the server 104 can include an application program that transforms media data. In one embodiment, the media is one or more pixels in image data or one or more samples in a sound recording.

In one embodiment, a raw data set is loaded into an embodiment of the present invention. The source of the raw data set may range from an electronic data set stored on the hard drive of a local or networked computer to a data set located on an intranet or the Internet to a data set acquired by some other data-capture device, such as a cellular telephone, camera, digital video recorder, etc. Furthermore, in one embodiment, the present invention as described herein may exist as an independent, stand-alone software application, while in an alternate embodiment, the present invention may exist as a toolbar plug-in that is dependent upon a separate software application, a Web service or application, etc. It is through comparison of the original raw data set data values with the algorithmically-transformed data values represented in the data overlay(s) that a user, the system, or some other applicable means may observe, if applicable, the presence of previously obscured or indiscernible raw data and/or patterns.

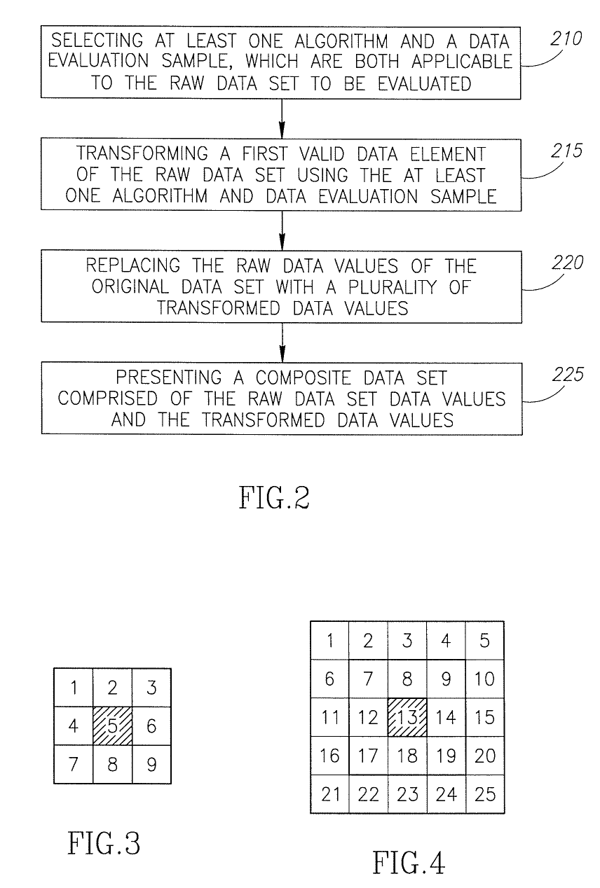

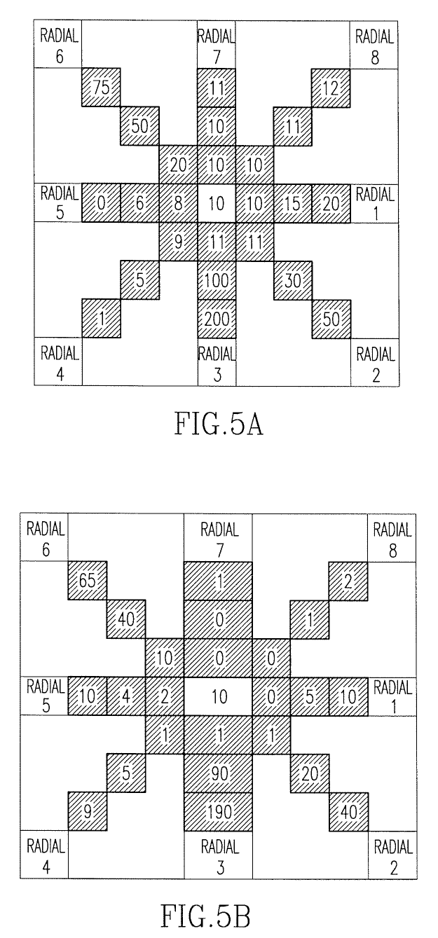

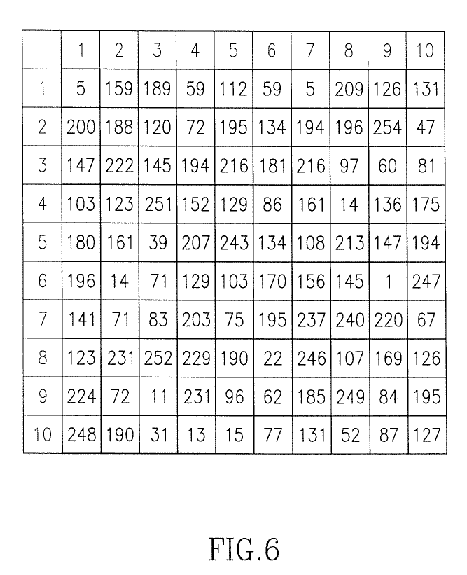

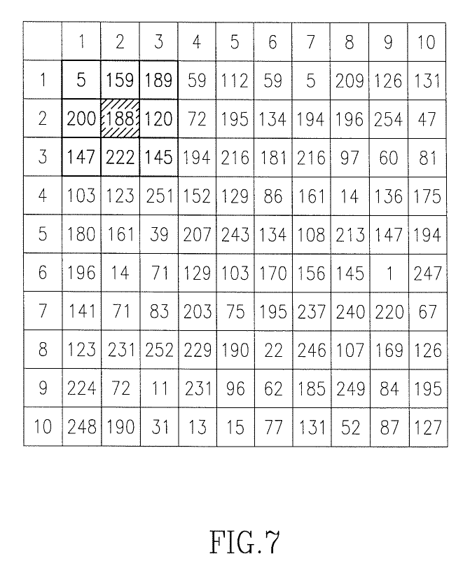

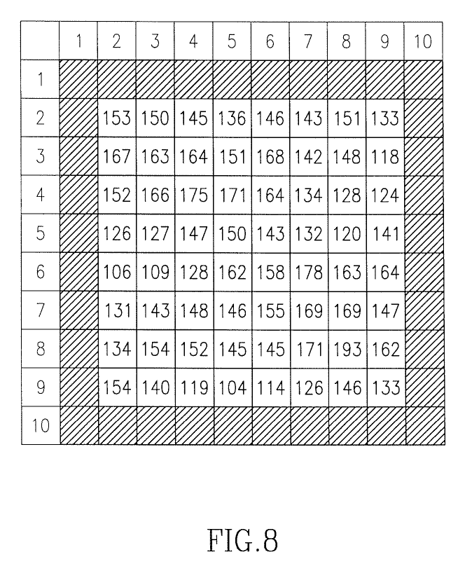

FIG. 2 shows a method for successful data transformation of a given raw data set. At block 210, at least one algorithm and a data evaluation sample is selected, which are both applicable to the raw data set to be evaluated. A list of sample algorithms are shown in relation to FIG. 5, and a list of sample data evaluation samples are shown in FIGS. 3-5. With regard to an imagery embodiment, for example, only algorithms that operate on grey-scale image data may be available for use during data transformation if the raw data set to be transformed is originally sourced from a grey-scale image. In an alternate embodiment, an independent transformation algorithm is presented for consideration and use during data transformation processing. In yet another embodiment, the transformation algorithms available for use in a particular transformation processing(s) may be further specified based on past popularity, frequency of use by other users in the accomplishment of a transformation process, etc. In one embodiment, the data evaluation sample to be used during the transformation of a given raw data set includes a range of applicable shapes, sizes and dimensions. At block 215, a first valid data element of the raw data set is transformed using at least one algorithm and data evaluation. In an embodiment, the algorithm is selected by a system, a user, or a combination of the both. An example of the first valid pixel transformation is shown in FIGS. 6-7. At block 220, the raw data values of the original data set are replaced with a plurality of transformed data values, which is shown in more detail in FIGS. 8-10. At block 225, a composite data set comprised of the raw data set data values and the transformed data values is presented to a user.

FIG. 3 depicts an adjacent pixel data evaluation sample. The sample as shown consists of a target data element, a pixel, and manipulates that pixel using the eight surrounding pixels.

FIG. 4 shows a target-like data evaluation sample. The target-level data evaluation sample consists of two levels of concentric squares of pixels surrounding a centralized pixel. In an alternate embodiment, the target-like data evaluation sample consists of an N-number of concentric circles or squares of pixels surrounding a centralized pixel(s).

FIG. 5 shows the starburst-like data evaluation sample. In one embodiment, the data evaluation sample is a Starburst TDA (target data area). A Starburst TDA is defined as a TDA around a TDE (target data element) with a number of radials emerging from the TDE. Each radial has a length of a number of pixels. A Starburst TDA, shown in FIG. 5, with given pixel values, will be used as an example to explain the algorithms and calculate their respective values. The Target Data Element (TDE) for this starburst is defined as the pixel in the center of the starburst. This is the data element (pixel) for which all the algorithm values are calculated. In FIG. 5A, the TDE has a pixel value of 10 (In one embodiment, a pixel can have a grey-scale or RGB value ranging from 0 to 255). There are 8 radials around the TDE numbered 1 to 8 as shown in FIG. 5A. Each radial is 3 pixels long. This specific TDA is described as Starburst 8 by 3 or generally as a Starburst. In an alternate embodiment, the starburst-like data evaluation sample consists of a series of radials, each containing N-number of pixels, surrounding a centralized pixel(s).

The systems and methods as disclosed herein draw from a number of algorithms to transform data. In an embodiment, at least one of the algorithms below is selected for use in transforming data. In most cases, an initial set of raw data is transformed in a series of steps using a plurality of algorithms. These algorithms include but are not limited to:

Sum of Radial Lengths—A radial length is defined as a number, for each radial, dependent upon whether the pixels in the radial are different from the TDE and how far they are from the TDE when they are different. In one example, the numbers 16, 8 and 4 are used. If the pixel nearest to the TDE in a radial has a value different then the TDE, then the radial length for that radial is 16. If the first nearest pixel value is the same as the TDE in the radial, but the second nearest pixel in the radial has a different value than the TDE, then the radial length for that radial is 8. If the farthest pixel in the radial has a different value than the TDE, then the radial length for that radial is 4. For the example shown in FIG. 5A, for Radial 1, the radial length is 8 as the second nearest pixel is different from the TDE but the first one is the same value as the TDE. For Radial 2 the radial length is 16 as the first nearest pixel is different in value from the TDE. The range for this algorithm is 0 to 128 (16 times 8) as the maximum value for each radial is 16. The following table shows the value for each radial length for the example shown in FIG. 5A, and calculates the sum at the end:

| Radial pointer | Radial Length |
|---|---|
| 1 | 8 |
| 2 | 16 |
| 3 | 16 |
| 4 | 16 |
| 5 | 16 |
| 6 | 16 |
| 7 | 4 |
| 8 | 8 |
| Sum | 100 |

Sum of First nonzero deviation—This value is calculated for each radial, by finding the first pixel closest to the TDE, which is different from the TDE. The difference is calculated between this pixel value and the TDE. The result is summed for all radials. The range for this algorithm is 0 to 2040 (255 times 8) as the maximum value for this algorithm for each radial is 255. The following table shows the first nonzero deviation for each radial length for the example shown in FIG. 5A, and calculates the sum at the end.

| Radial pointer | 1st non zero deviation |
|---|---|
| 1 | 5 |
| 2 | 1 |
| 3 | 1 |
| 4 | 1 |
| 5 | 2 |
| 6 | 10 |
| 7 | 1 |
| 8 | 1 |
| Sum | 22 |

Sum of deviations over radial lengths—This value is calculated by dividing the value for Algorithm 2 (first non zero deviation) by value for Algorithm 1 (radial length) for each radial. The result is then summed for all the radials. The range for this algorithm is 0 to 510. For the example shown in FIG. 5A, for Radial 1 the value will be 5 (first non zero deviation) divided by 8 (radial length) which is 0. The values for all the radials are calculated and summed as shown below:

| Radial pointer | First non zero deviation | Radial Length | Divide |
|---|---|---|---|
| 1 | 5 | 8 | 0 |
| 2 | 1 | 16 | 0 |
| 3 | 1 | 16 | 0 |
| 4 | 1 | 16 | 0 |
| 5 | 2 | 16 | 0 |
| 6 | 10 | 16 | 0 |
| 7 | 1 | 4 | 0 |
| 8 | 1 | 8 | 0 |
| | | Sum | 0 |

Absolute value count—This value is the count of all the unique values in the TDA, excluding the TDE. For the example shown in FIG. 5A, the absolute value count is 16 as there are 16 unique values in the TDA. The range for this algorithm is 1 to 24. This algorithm is an indicator of the homogeneity of the TDA.

Deviation count—This value is the count of all the unique deviations in the Starburst. For the example shown in FIG. 5A, the deviation count is 12 as there are 12 unique deviations in the TDA. The range for this algorithm is 1 to 24.

Sum of absolute value over absolute value count—This value is the sum of all the absolute values in the TDA divided by the unique absolute value count. This algorithm is less sensitive than the sum of absolute value algorithm or the absolute value count algorithm.

Sum of deviation over deviation count—This value is the sum of all the deviations divided by the unique deviation count. This algorithm is less sensitive than the sum of deviation or the deviation count algorithms.

Spread of absolute values—This value is the difference between the highest absolute value and the lowest absolute value. For the example shown in FIG. 5A, the resulting value is 200. The range for this algorithm is 0-255. This algorithm is independent of the shape and size of the TDA.

Spread of deviations—This value is the difference between the highest deviation and the lowest deviation. For the example shown in FIG. 5A, using the deviation snowflake, the resulting value is 190. The range for this algorithm is 0-255. This algorithm is independent of the shape and size of the TDA.

Mean value—This value is the mean of all the values in the in the TDA, calculated by adding all the values in the TDA and dividing by the number of pixels in the TDA. This algorithm is independent of the shape and size of the TDA.

Mean Different Value—This value is the mean of the different values in the in the TDA. This is calculated by determining which values are present in the TDA and summing the different values in the TDA and dividing by the number of different values in the TDA. This algorithm is independent of the shape and size of the TDA.

Absolute Deviation—This value is the mean absolute deviation, as calculated by determining the mean of the values in the values in the TDA, and summing the absolute differences between each value in the TDA and the mean value, and then dividing the resulting sum by the number of values in the TDA. This algorithm is independent of the shape and size of the TDA.

Value Kurtosis—This value is the fourth cumulant divided by the square of the variance of the probability distribution of the values in the TDA, and is a measure of the “peakedness” of the distribution of values in the TDA. It is calculated in the standard statistical method using the values in the TDA. This algorithm is independent of the shape and size of the TDA.

Deviation Kurtosis—This value is the fourth cumulant divided by the square of the variance of the probability distribution of the deviation values in the TDA, and is a measure of the “peakedness” of the distribution of values in the TDA. It is calculated in the standard statistical method using the values in the TDA. This algorithm is independent of the shape and size of the TDA.

Value Skewness—This value is the sample skewness if the values in the TDA, which is an indicator of asymmetry of the distribution of values in the TDA. It is calculated using the standard statistical method for sample skewness. This algorithm is independent of the shape and size of the TDA.

Deviation Skewness—This value is the sample skewness if the deviation values in the TDA, which is an indicator of asymmetry of the distribution of deviation values in the TDA. It is calculated using the standard statistical method for sample. This algorithm is independent of the shape and size of the TDA.

Value Variance—This value is the sample variance of the values in the TDA. It calculates using the standard statistical method, and can be summarized as: compute the mean of the values; subtract the mean from each number and square each result; take the mean of these squares. This algorithm is independent of the shape and size of the TDA.

Deviation Variance—This value is the sample variance of the deviation values in the TDA. It is calculated using the standard statistical method, and can be summarized as: compute the mean of the deviation values; subtract the mean from each deviation and square each result; take the mean of these squares. This algorithm is independent of the shape and size of the TDA.

Low Value Spread—This value is calculated by determining the spread of values in the TDA, and if the value is above 16, setting it to 0. Spread values less than or equal to 16 are returned. This is an indicator of where subtle variations in the data are present, and treats large variations as if no variation occurred. This algorithm is independent of the shape and size of the TDA.

Low Deviation Spread—This value is calculated by determining the spread of deviations in the TDA, and if the value is above 16, setting it to 0. Spread values less than or equal to 16 are returned. This is an indicator of where subtle variations in the data are present, and treats large variations as if no variation occurred. This algorithm is independent of the shape and size of the TDA.

Existence of Near Neighbor—The value for this algorithm is a bit array, one bit allotted per radial. The value for this array is calculated by checking the value for the pixel nearest to the TDE, for a radial. If it is ON (pixel value greater than 0), a 1 is put in the array for that radial position. For the example shown in FIG. 5A, the bit array will be 8 bits long (a byte) as we have 8 radials. For the example shown in FIG. 5A, the bit array will be 11111111 as all the pixel values nearest to the TDE are ON.

Existence of Middle Neighbor—The value for this algorithm is a bit array with one bit allotted per radial. The value for this array is calculated by checking the value for the pixel second nearest to the TDE, for a radial. If it is ON (pixel value greater than 0), a 1 is put in the array for that radial position. For the example shown in FIG. 5A, the bit array will be 8 bits long (a byte) as we have 8 radials. For the example shown in FIG. 5A, the bit array will be 11111111 as all the pixel values second nearest to the TDE are ON for each radial.

Existence of Far Neighbor—The value for this algorithm is a bit array with one bit allotted per radial. The value for this array is calculated by checking the value for the pixel third nearest to the TDE, for a radial. If it is ON (pixel value greater than 0), a 1 is put in the array for that radial position. For the example shown in FIG. 5A, the bit array will be 8 bits long (a byte). For the example shown in FIG. 5A, the bit array will be 11110111 as all the pixel values third nearest to the TDE are ON except for radial 5.

Masking—Any algorithm value can be masked by a specific bit mask. In our current implementation, the default bit mask for image processing used is 0XFC (binary 11111100), which sets the last two bits and the bits higher than 8 to 0. For example, if the result of an algorithm would return a value of 511 (0x1FF) applying the default mask would remove the high bit and the two low bits, resulting in an actual algorithm value return as 252. Masking the algorithm's value makes the algorithm less sensitive by returning the same algorithm value for multiple sets of input values.

Input Value Division—Any algorithm may use an input value divisor, and all algorithms have a default divisor of 1. The value for each pixel in the TDA is divided by the divisor before the algorithm specific processing is performed. Dividing the algorithm's input values makes the algorithm less sensitive by returning the same algorithm value for multiple sets of input values, and generally has a more significant effect than masking as discussed above.

In one example, an image is used for data transformation. Assume that the transformation algorithms to be used in evaluation of the raw data set include the “Mean” algorithm (A1), the “Median” algorithm (A2) and the “Spread” algorithm (A3). A mean is determined by the sum of the observations divided by the number of observations, or in this case the sum of the pixels in the data evaluation sample divided by the number of pixels in the data evaluation sample. The median of a finite list of numbers is found by arranging all the observations from lowest value to highest value and picking the middle one. If there is an even number of observations, the median is not unique, so one often takes the mean of the two middle values. In this case, all of the values in the data evaluation sample are ordered and the middle number is the median. In order to determine spread, the lowest value in the data evaluation sample is subtracted from the highest value in the data evaluation sample. In one embodiment, algorithmic transformation calculations may be performed on each data element within the data evaluation sample, including the subject data element(s). In an alternate embodiment, the subject data element(s) may be excluded from inclusion in the algorithm transformation calculations. For the purposes of the following examples, assume that the subject data element of the data evaluation sample is included in the transformation calculations.

FIG. 6 shows a ten-pixel by ten-pixel raw data set example for a two-dimensional, grey-scale image. Transformation processing of the ten-by-ten pixel raw data set using the first transformation algorithm, A1, initiates at the first valid pixel (2, 2). When an image is used, a pixel is the data element being analyzed. In order to begin the processing of an image, the systems and methods determine the first valid pixel. The first valid pixel is one that is surrounded on all requisite sides by the appropriately-patterned and correct number of pixels as defined by the data evaluation sample being used. For example, using a one-pixel concentric square data evaluation sample (hereafter “adjacent pixel data evaluation sample”), the first valid pixel is (2, 2). FIG. 7 shows the pixel (2, 2) as used in the current example.

The result of the first transformation algorithm, A1, is a value of 153. 153 is determined by adding together the surrounding pixel values, 5+159+189+120+145+222+147+200+188 and then dividing by 9 which results in a mean value of 153. This transformed value, 153, is subsequently substituted for the corresponding raw data value of pixel (2, 2), which is 188 as shown in FIG. 6, and becomes the first member or data element of the A1 data overlay. Here, the data overlay functions to relay an alternative visualization of the raw data set as achieved through data transformation while ensuring preservation of the original and/or underlying meaning within the raw data by substituting the raw data value(s) with the transformed data value(s). FIG. 8 shows an example of a complete data overlay and displays a new transformed image. The transformation processing with A1 then steps to the next valid pixel (3, 2) of the raw data set and returns a value of 150. 150 is determined by adding together the surrounding pixel values, 159+189+59+72+194+145+222+188+120 and then dividing by 9 which results in a mean value of 150. This transformed value for pixel (3, 2) is used as a substitution for the corresponding raw data value for pixel (3, 2), which is 120 in the resultant A1 data overlay. Transformation processing of the raw data set using A1 continues for all valid pixels, for a total of 64 pixels, in the raw data set. Once the A1 data overlay is populated with the corresponding transformed data values, transformation processing of the raw data set using A2, and finally A3, may proceed. In one embodiment, transformation of the raw data set with each algorithm results in a new data overlay, and therefore each algorithm is run in sequence, and begins running on the completion of the prior algorithm in the queue. Separate data overlays are then populated with the respective transformation results of the subsequent transformations. In an alternate embodiment, a single data overlay may be used to present all transformation results.

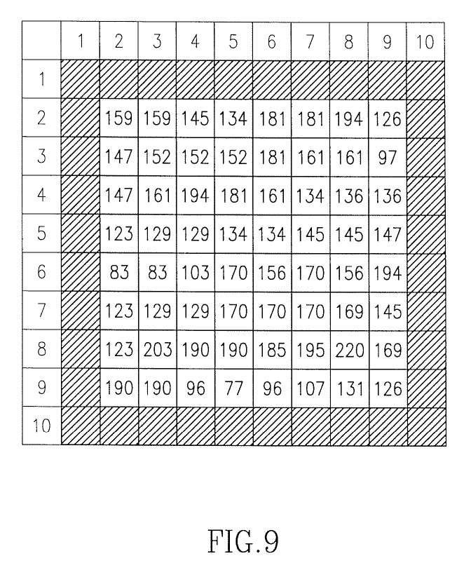

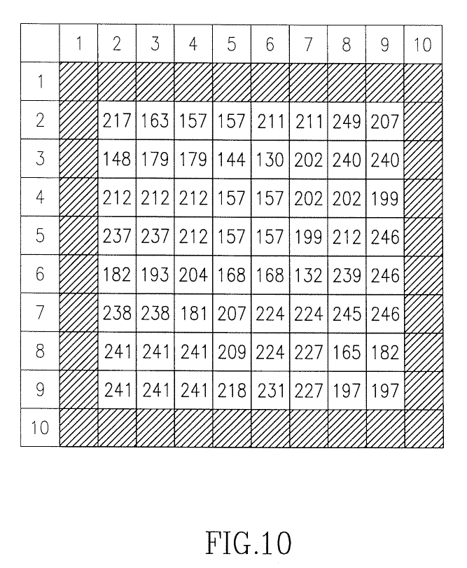

In an alternate instance of the ten-by-ten raw data transformation, processing proceeds whereby each valid pixel in the raw data set is transformed with each available transformation algorithm before transformation processing steps to the next valid pixel of the raw data set. For example, transformation processing with A1 initiates at pixel (2, 2) and yields a resultant transformed data value of 153. As previously described, this transformed data value is then used to substitute for the raw data value, 188, at pixel (2, 2) in the A1 data overlay. However, instead of transformation processing with A1 continuing for the next valid pixel (3, 2), transformation processing remains at pixel (2, 2) where it is processed using A2. The resulting transformed data value is 159. 159 is determined by taking the values of the surrounding pixels and finding the median number, and this value is subsequently used to replace the corresponding raw data value for pixel (2, 2) in the resultant A2 data overlay. FIG. 9 shows an A2 data overlay. Moreover, processing of pixel (2, 2) is only finished after it is transformed using A3. The resultant value is 217, which is determined by taking the spread of the eight surrounding pixels and the (2, 2) pixel, and this transformed data value is used to replace the corresponding raw data value for pixel (2, 2) in the resultant A3 data overlay. FIG. 10 shows an A3 data overlay.

Once pixel (2, 2) is transformed using A1, A2 and A3, and the respective data overlays are updated with the appropriate corresponding results, transformation processing steps to the next valid pixel (3, 2) in the raw data set.

As transformation processing proceeds through the valid data elements of a given raw data set, in one embodiment, each new transformation algorithm processes using the raw data values and not the newly-calculated transformation values resulting from previous runs of other transformation algorithms. In an alternate embodiment, N-order processing may be used to transform the original raw data set as each subsequent transformation algorithm processes on the transformation values achieved in previous transformation processing runs. In alternate embodiments, transformation algorithms may perform second, third or N-order processing on previously obtained algorithmically-transformed data values.

While in one embodiment, the resultant transformation value(s) of a particular data element(s) is used to substitute for the original raw data value(s) of the corresponding data element(s), as described previously, in an alternate embodiment, such as N-order processing where accurately storing the results of previous transformation processing runs may become exceedingly cumbersome and important, the resultant transformation value(s) may be temporarily or permanently stored in an algorithm value cache, or other storage device, for use later. For example, one embodiment, and corresponding to each transformation algorithm to be used, is a previously-generated algorithm value cache(s) for the interim storage of the corresponding transformation results. In other words, the resultant transformation values obtained through evaluation of the ten-by-ten raw pixel data set with A1 may be stored in algorithm value cache 1. Instead of the transformed data values being used directly to populate corresponding data overlays, as previously described, each algorithm value cache may be used as an intermediary to eventually populate a corresponding data overlay of resultant transformation values as obtained after evaluation of the raw data set with the transformation algorithm(s); as such, algorithm value cache 1, which stores the transformation results from evaluation of the raw data set with A1, is used to populate data overlay 1.

For example, in one instance of the ten-by-ten pixel raw data set each valid pixel within the raw data set is transformed with A1 before transformation processing with A2 initializes. As such, the entire algorithm value cache for the resultant transformation values achieved using A1 is populated first with the algorithm value caches, which correspond to A2 and A3, following. In an alternate embodiment, however, the first valid pixel of the raw data set is transformed using the plurality of selected transformation algorithms. As such, the respective algorithm value caches for A1, A2 and A3 each gain the transformation values corresponding to the first valid pixel of the raw data set, and then transformation processing steps to the next valid pixel. In one embodiment, these algorithm value caches are used to generate respective data overlays of transformed data. It is important to note that no matter the methodology, throughout transformation processing of the raw data set, the raw data remains unchanged and unaffected as the results of the transformation process on the raw data set are maintained within associated user-specified, preset, automatically-determined, and/or industry- or system-acceptable algorithm value caches and/or data overlays.

Multi-banded data is defined in one imagery embodiment as RGB data in a color image; RGB is an additive model in which certain combinations of red, green and blue intensities are combined in various ways to reproduce other colors. Typical display adapters (i.e., computer monitors) use up to 24-bits of information for each pixel, and this is usually apportioned with 8 bits each for red, green and blue, giving a range of 256 possible values for each hue. Therefore, a band of data is defined as the 8 bits of data for the selected band in the 24 bits of information for each pixel. The red band consists of the first 8 bits, the green band the second 8 bits and the blue band the final 8 bits; each of these bands in a pixel may be manipulated as shown below. For example a white pixel is written as (255, 255, 255), and each of these numbers are stored in the raw data table in memory and the data can be transformed. If the red band was selected the first 255 would be selected and transformed.

In the case of multi-banded data, such as RGB in a color image, one or a plurality of transformation algorithms may be processed on one band (e.g., the red band) or on a combination of bands (e.g., the red and green bands) in one or a plurality of data elements. A user selects the data bands and algorithms, or in an alternate embodiment, the data bands and algorithms are automatically selected by a computer executable code run on a processor. These evaluation steps may be repeated N-number of times until the final data evaluation sample applicable to the final valid data element is evaluated.

While in one embodiment, the same transformation algorithm(s) may be used to process all valid data elements of a given raw data set, in an alternate embodiment, the original raw data set may be transformed using a different transformation algorithm(s). Based on the image type, for example, a user may select different portions of the image to be transformed using different transformation algorithms. For example, in an imagery embodiment, the sky portion of a particular raw data set may be transformed using one transformation algorithm(s), while the ocean portion of the same raw data set may be transformed using a different transformation algorithm(s). In one embodiment, this is accomplished when the sky and water portions of the raw data set and/or different transformation algorithms are individually selected. These steps may then be repeated for each portion of the raw data set that is to be transformed separately.

Once the transformation process is complete, the resulting transformation values are recombined in some system-acceptable manner, such as a corresponding algorithm value cache and/or data overlay, so as to generate final transformed data values in the final transformed data set. In other words, an image becomes a newly transformed image; a sound file becomes a newly transformed sound file, etc. Once the data overlays and/or algorithm value caches are generated, an embodiment of the present invention may output the transformed data, as well as the original raw data set data values, back to the user as a composite data set.

In one embodiment, a new image is formed after running an algorithm on an original image. The original image data is not manipulated. Once the algorithm has been executed and a transformed set of data has been created, a new image or a transformation layer is produced. In order to develop the transformational layer, the system calculates the range of values found in the original data or the raw data set values. The system stores in memory the maximum value for a pixel and the minimum value of the pixel. A new blank image is created the size of the original image, which is stored in a memory. Once these numbers are assigned for each data element in the transformed data, the location of the pixel is stored, then the pixel's grey-scale color value is calculated. In an embodiment, the formula use is (the transformed data value−the minimum value)/(maximum value−minimum value)*255. The pixel is then assigned the grey-scale color value as calculated in the transformation layer at the stored pixel location.

In one embodiment, a composite image is produced. A composite image is an image that contains at least one layer or allows for the combination of two or more transformed data sets, which are combined to show a final image. Each set of transformed data is referred to as a layer; the creation of the layer is shown directly above. Each layer is sorted in composite order from lowest to highest. The sort process enables the system to choose the final value of a pixel in a composite image based on the final value of the highest ranked layer. A new blank image is created the size of the original image, which is stored in a memory. For each layer to be included in the composite image, and for each pixel in the transformation layer image, the location of the pixel is stored. The pixel color is retrieved from the layer. If the pixel color is not black, the pixel color of the composite image is painted the pixel color at the pixel location. This process results in a composite image where each pixel has the color of the latest non-black pixel from the sorted list of layer images.

In an embodiment, a composite image contains multi-banded data. For transformations that use band composite generation, the resulting composite is generated as follows: A user chooses the transformation or original layers to assign to each of the red, green and blue bands. A new blank image is created that is the size of the original image and it is stored in the memory as a composite image. For each pixel location, the location of the pixel is stored. If the user selected an image to be place in the red band, a red band value is retrieved from the image in the layer selected by the user. If the user selected an image to be placed in the green band, then the value of the green band is retrieved from the image in the layer selected by the user. If the user selected an image to be placed in the blue band then the value of the blue band is retrieved from the image in the layer selected by the user. A new color is obtained for the red, green and blue bands. The pixel at the stored location is assigned the created color. This process results in an image with colors generated in combination from the values from the bands selected by the user.

When the user is ready to form a composite transformation image, the user may place the grey-scale data values associated with the first transformation algorithm in the red band of the composite image; the grey-scale data values associated with the second transformation algorithm in the green band of the composite image; and the grey-scale data values associated with the third transformation algorithm in the blue band of the composite image. In this way, the user has created a “colored” image with three grey-scale data values (one each for the red, green and blue bands, for example) associated with each data element of the composite image.

In an embodiment, a user may select a transformation that outputs contrasted colors. Contrasted colors highlight differences in a transformed layer and are used to distinguish closely related bands of data. A palette of colors is constructed so that adjacent colors in the palette have a significant visual contrast. For example, a lighter shade of green is next to a darker shade of red, which is next to a lighter shade of blue, continuing until sufficient colors are present in the palette. In order to determine a pixel color, in a contrasted colors embodiment, a range of values is calculated from the original media and the minimum and maximum values are stored. For each pixel in the transformed layer, the location of the pixel is stored. The pixels color index is calculated using the formula (pixel algorithm value−minimum value)/(maximum value−minimum value)*count of colors in the palette. The pixel's color value is determined by retrieving the color from the palette at the pixel color index. The pixels color value is assigned in the transformation layer image at the stored pixel location. In a two-dimensional imagery embodiment, the transformed image is presented in a contrasting color palette or other display format. A user selects a range of transformed data values based on what information is to be displayed after data transformation is complete. The colors are selected to highlight the transformed data and are used as a tool to identify transformed data. For example, a range of resulting algorithmically-transformed data values (e.g., 0-3) may be automatically assigned to a color (e.g., bright yellow), with the following range of transformed data values (e.g., 4-7) assigned to a contrasting color (e.g., dark blue) to the previous color, with the following range of transformed data values (e.g., 8-11) assigned to a contrasting color (e.g., light orange) to the previous color, and so on until the ranges of transformed results is exhausted. In an alternate embodiment, the user is given discretion to choose the colors in which particular ranges of transformed data values are colored. Here, in one embodiment, the user may assign each range of resulting transformed data values (e.g., 0-3, 4-7, 8-11, etc.), as by an embodiment of the present invention, to a user-specified color (e.g., magenta, lime green, red, etc.); in an alternate embodiment, the user may assign each user-specified range of resulting transformed data values (e.g., 0-4, 5-6, 7-9, etc.) to a predetermined color (e.g., bright yellow, dark blue, light orange, etc.); in an alternate embodiment, the user may assign each user-specified range of resulting transformed data values (e.g., 0-4, 5-6, 7-9, etc.) to a user-specified color (e.g., magenta, lime green, red, etc.). In an alternate embodiment, the same or a similar methodology may be used and/or applied to any other applicable data type, modality, submodality, etc.

Once the specifications for the transformation results output are finalized, the user may select one or a plurality of the transformed data sets to include as part of the final composite data set. In one embodiment, the user may select one data set for each of the respective and applicable data bands. The final output may be colored to represent to a user exactly what each algorithm revealed within the image. Colors may be automatically set or assigned by a user. For example with regard to the ten-by-ten pixel raw data set, the algorithmically-transformed data values obtained using A1 may be placed in the red band, the algorithmically-transformed data values obtained using A2 may be placed in the green band, and the algorithmically-transformed data values obtained using A3 may be placed in the blue band for an original RGB-color model image. In an alternate embodiment, the user may select a single transformed data set (such as those results obtained from transformation of the raw data set using A1) to be used in each color band; for example, the algorithmically-transformed data values obtained using A1 may be placed in the red, green and blue bands for an original RGB-color model image. While only one transformed data set may be selected for use in an applicable data band, the same transformed data set may be selected for use in all applicable data bands.

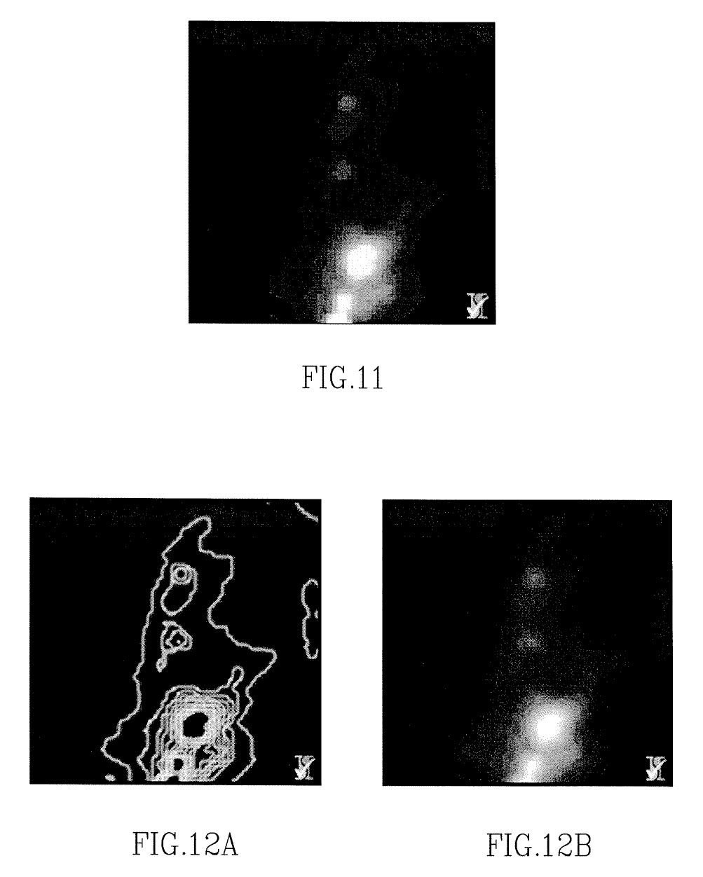

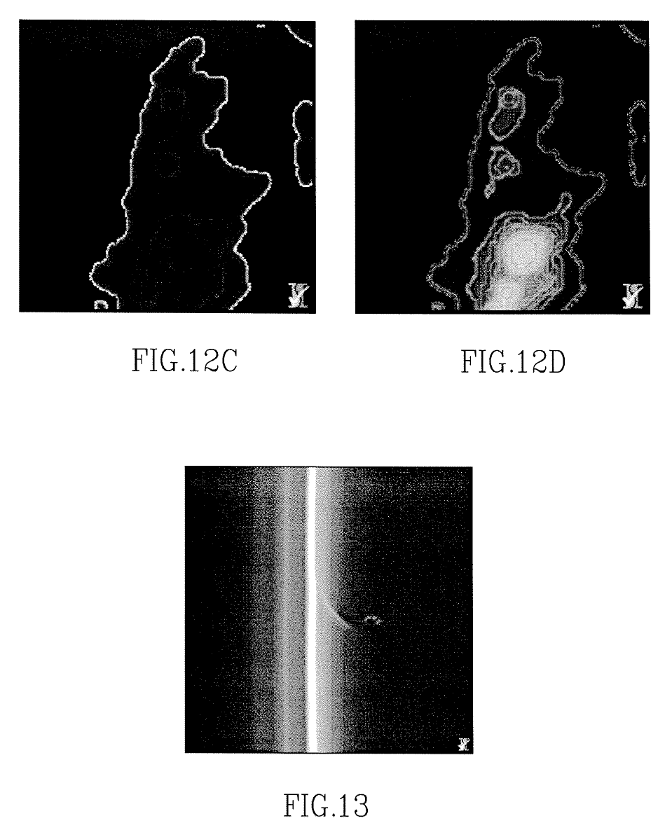

FIG. 11 shows a star cloud image used for data transformation. This image is transformed to create transformed images as shown in FIGS. 12A-D. All images were transformed using the starburst data evaluation sample, and each image is transformed based on the original data values and not any transformed values. FIG. 12A shows a transformed image achieved using the sum radial distribution algorithm. FIG. 12B shows a transformed image achieved using the mean different values algorithm. FIG. 12C shows a transformed image achieved using the spread over mean algorithm. FIG. 12D shows a composite image transformed using the sum of radial distribution, mean different and the spread over mean algorithms.

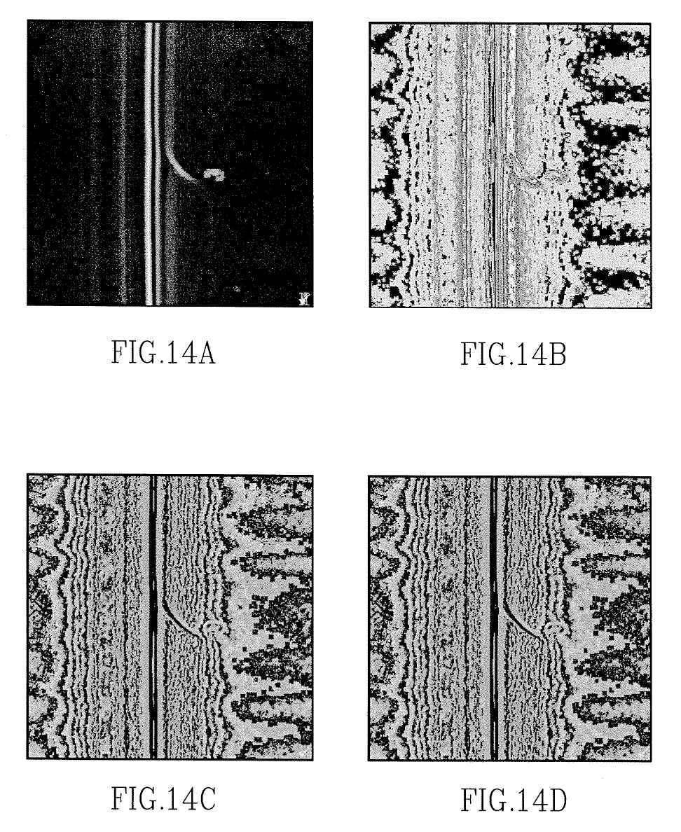

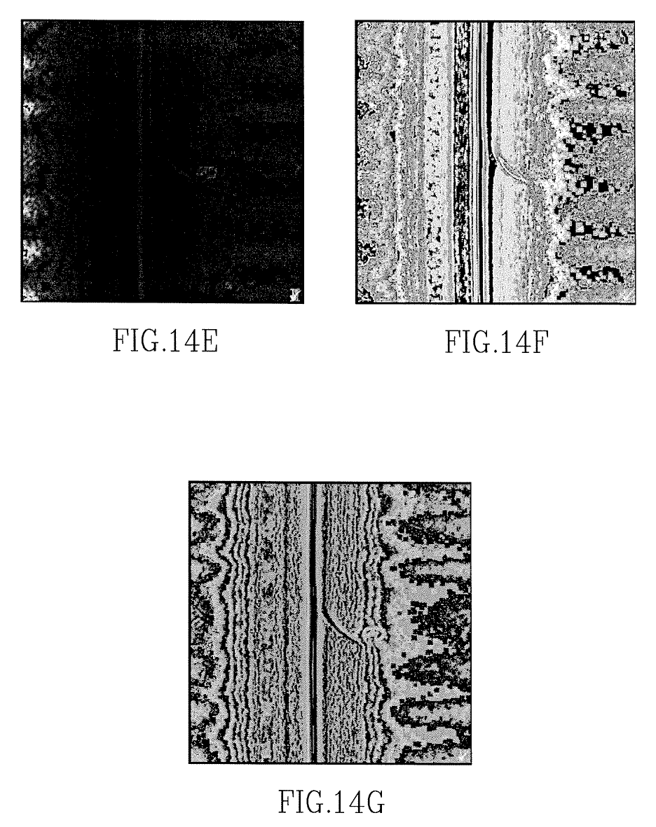

FIG. 13 shows a ring of Saturn used for data transformation. All images were transformed using the starburst data evaluation sample and each image is transformed based on the original data values and not any transformed values. FIG. 14A shows a transformed image achieved using the value spread algorithm. FIG. 14B shows a transformed image achieved using the value spread algorithm and is visualized using contrasting colors. FIG. 14C shows a transformed image achieved using a skewness algorithm. FIG. 14D shows a transformed image achieved using the skewness algorithm and is visualized using contrasting colors. FIG. 14E shows a transformed image achieved using a spread over mean algorithm. FIG. 14F shows a transformed image achieved using a spread over mean algorithm and is visualized using contrasting colors. FIG. 14G shows a composite image transformed using the value spread, the skewness and the spread over mean algorithms.

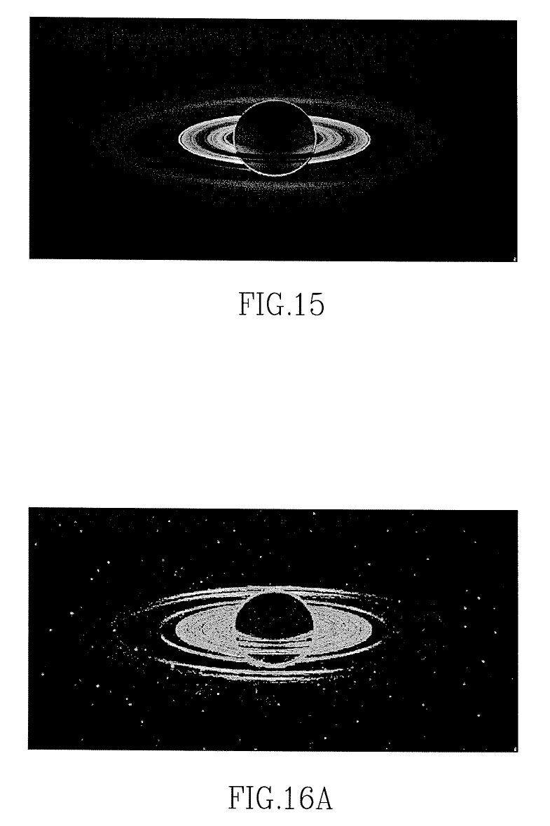

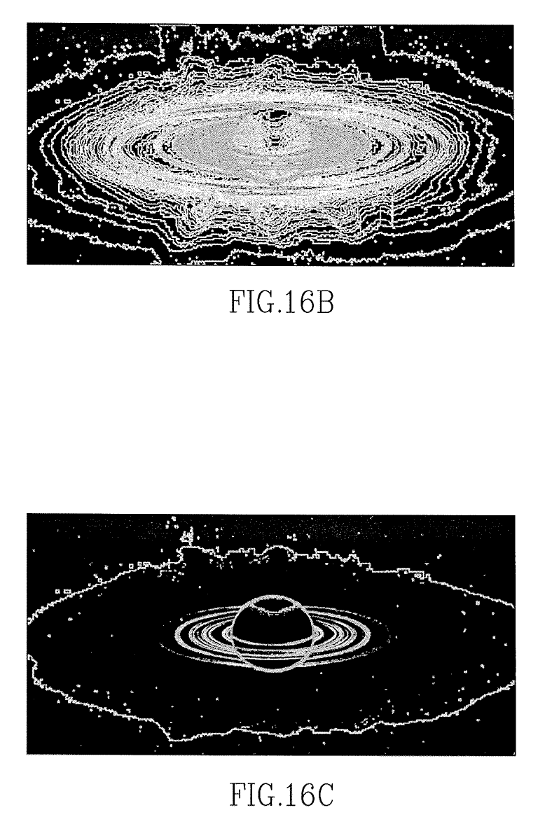

FIG. 15 shows an image of Saturn used for data transformation. All images were transformed using the starburst data evaluation sample and each image is transformed based on the original data values and not any transformed values. FIG. 16A shows a transformed image achieved using the spread over mean deviation algorithm. FIG. 16B shows a transformed image achieved using the deviation count quotient minus different over unique pixels algorithm. FIG. 16C shows a transformed image achieved using the spread over mean algorithm and presented in contrasting color.

While the preferred embodiment of the invention has been illustrated and described, as noted above, many changes can be made without departing from the spirit and scope of the invention. Accordingly, the scope of the invention is not limited by the disclosure of the preferred embodiment. Instead, the invention should be determined entirely by reference to the claims that follow.

The embodiments of the invention in which an exclusive property or privilege is claimed are defined as follows:

1. A method for data transformation comprising:
storing a plurality of pixel values from an original image file in a memory;
for each pixel in the memory, executing at least one algorithm on a processor, the algorithm being configured to transform the pixels stored in the memory into transformed data values, the algorithm processing a plurality of subsets of the data, each subset comprising:
a pixel surrounded by a plurality of pixels such that the pixel processed is surrounded by the appropriately patterned and correct number of pixels as defined by a data evaluation sample being used;
storing the transformed data values in the memory;
combining the transformed data set with the original data set in order to form a transformed data set; and
presenting on a user interface an image representing the transformed data set.

2. The method of claim 1 wherein each pixel in the transformed data set is assigned a grayscale value.

3. The method claim 2 wherein an algorithm executed is a sum radial distribution algorithm.

4. The method claim 2 wherein an algorithm executed is a mean different values algorithm.

5. The method claim 2 wherein an algorithm executed is a sum over mean algorithm.

6. The method claim 2 wherein an algorithm executed is a spread over mean algorithm.

7. The method claim 2 wherein the data evaluation sample used is a starburst pattern.

8. The method claim 2 wherein the data evaluation sample used is a concentric square pattern.

9. The method claim 2 wherein the data evaluation sample used is a concentric circle pattern.

10. A system for data analysis and feature recognition comprising:
a memory configured to contain pixel values from an original image and for a transformed image;
a display; and
a processor in data communication with the display and the memory, the processor comprising:
a first component configured to store a plurality of pixel values from an original image file in a memory;
for each pixel in the memory a second component configured to execute at least one algorithm on a processor, the algorithm being configured to transform the pixels stored in the memory into transformed data values, the algorithm processing a plurality of subsets of the data, each subset comprising: a pixel surrounded by a plurality of pixels such that the pixel processed is surrounded by the appropriately patterned and correct number of pixels as defined by a data evaluation sample being used;
a third component configured to store the transformed data values in the memory;
a fourth component configured to combine the transformed data set with the original data set in order to form a transformed data set; and
a fifth component configured to present on a user interface an image representing the transformed data set.

11. The system of claim 10 wherein each pixel in the transformed data set is assigned a grayscale value.

12. The system of claim 11 wherein an algorithm executed is a sum radial distribution algorithm.

13. The system of claim 11 wherein an algorithm executed is a mean different values algorithm.

14. The system of claim 11 wherein an algorithm executed is a sum over mean algorithm.

15. The system of claim 11 wherein an algorithm executed is a spread over mean algorithm.

16. The system of claim 11 wherein the data evaluation sample used is a starburst pattern.

17. The system of claim 11 wherein the data evaluation sample used is a concentric square pattern.

18. The system of claim 11 wherein the data evaluation sample used is a concentric circle pattern.

19. A method for data transformation comprising:
storing a plurality of data values from an original data set in a memory;
for each data value in the memory, executing at least one algorithm on a processor, the algorithm being configured to transform the data values stored in the memory into transformed data values, the algorithm processing a plurality of subsets of the data, each subset comprising:
a data value surrounded by a plurality of data values such that the data value processed is surrounded by the appropriately patterned and correct number of data values as defined by a data evaluation sample being used;
storing the transformed data values in the memory;
combining the transformed data set with the original data set in order to form a transformed data set; and
presenting on a user interface a transformed data set.
